(19) United States
(12) Patent Application Publication
(10) Pub. No.: US 2005/0107513 A1
(43) Pub. Date: May 19, 2005

(54) Polyoxymethylene molding compound and molded body produced therefrom

(76) Inventor: Nicolai Papke, Mainz-Kastel (DE)

Correspondence Address: CONNOLLY BOVE LODGE & HUTZ, LLP, P O BOX 2207, WILMINGTON, DE, 19899, US

(21) Appl. No.: 10/506,553

(22) PCT Filed: Mar. 4, 2003
(86) PCT No.: PCT/EP03/02174

(30) Foreign Application Priority Data
Mar. 5, 2002 (DE) 10209420.9
Mar. 5, 2002 (DE) 10209756.9

(51) Int. Cl. C08K 3/40

(52) U.S. Cl. 524/494

(57) ABSTRACT

The invention relates to a polyacetal molding compound that contains a polyacetal homo- or copolymer, an additive and 0.0001% by weight to 1.0% by weight of a substance that catalyzes a chemical reaction between the polyacetal matrix polymer and the surface of the additive, and that contains the element Bor and is no Brønsted acid.

The present invention relates to novel polyoxymethylene molding compositions with improved mechanical properties.

The superior mechanical properties of polyoxymethylene molding compositions are the reason for their use in numerous applications. To improve their properties, the polyoxymethylene homo- and copolymers are provided with additives to adapt the properties to the applications, for examples being mineral fillers, reinforcing fibers, or impact modifiers.

The effect of these additives on the properties of the molding composition is affected by the coupling of the additive to the plastics matrix. This often means that some additives are not suitable for all plastics, or that they are provided with sizes which bring about improved coupling to the plastics matrix.

The additives here, in particular reinforcing fibers, are coated with sizes, and once the size has been dried these fibers are incorporated into the molten polymer. However, this procedure is often insufficient in the case of polyacetal.

JP-A-09/176,443 therefore describes the use of orthoboric acid together with fibrous reinforcing materials as an additive in polyoxymethylene molding compositions, thus giving a material with good mechanical properties.

EP-A-765,910 describes the use of boric acids with inorganic fillers in the processing of polyacetals, giving moldings with excellent mechanical properties. The boric acid brings about a degree of attack on, and degradation of, the plastic, thus producing reacting groups which react with the surface of the inorganic filler.

However, a disadvantage with the use of boric acid is that polyacetal is at least to some extent decomposed by boric acid—as it is by any other Brönsted acid—the result being that at least some of the gain in mechanical stability is lost via the degradation of the polymer. In addition, the degradation increases the formaldehyde emission, and the extent of the advantageous effect is highly dependent on the nature of the fillers used and their surface treatment, or the material used as size.

The object therefore consisted in finding compounds whose addition brings about improved coupling of additives, such as mineral fillers, fibrous reinforcing materials, and/or impact modifiers, but brings about less degradation of the polyacetal, and thus providing a polyacetal molding composition which has a very low level of decomposition of the polyacetal, has relatively high stability and aging resistance, has lower formaldehyde emission, has high strength and impact strength, high tensile strain at break and high weld line strength, and better stability in contact with fluids, the effect being independent of the fiber type or material used as size.

Another object consisted in finding compounds whose addition brings about improved coupling of additives, in particular of reinforcing fibers, to the polyacetal matrix but which bring about less degradation of the polyacetal, and thus providing a long-fiber-reinforced thermoplastic polyacetal structure with improved mechanical properties and having the advantageous properties described above.

The improved coupling of the additive phase to the polyacetal matrix is apparent in increased interfacial adhesion and—depending on the nature of the additive—in improved mechanical properties of the molding, and/or in improved dispersion of the additive in the polyacetal matrix.

This object is achieved via a polyacetal molding composition comprising at least one catalyst which catalyzes a chemical reaction between the polyacetal matrix polymers and the surface of the additive, and which does not comprise the element boron, and is not a Brönsted acid.

The present invention therefore provides a polyacetal molding composition comprising

from 20 to 99% by weight of a polyacetal homo- or copolymer,

from 0.1 to 80% by weight of an additive, and

up to 1.0% by weight, preferably from 0.00001 to 0.5% by weight, of a catalyst which catalyzes a chemical reaction between the polyacetal matrix polymer and the surface of the additive, where the catalyst does not comprise the element boron and is not a Brönsted acid.

In one preferred embodiment, the present invention provides a long-fiber-reinforced thermoplastic polyacetal molding composition comprising

from 20 to 90% by weight of a polyacetal

from 10 to 80% by weight of a reinforcing fiber,

up to 1.0% by weight, preferably 0.00001 to 0.5% by weight of at least one catalyst which catalyzes a chemical reaction between the polyacetal matrix polymer and the surface of the additive, where the catalyst does not comprise the element boron and is not a Brönsted acid.

This type of polyacetal molding composition or this type of long-fiber-reinforced polyacetal molding composition has high strength, excellent impact strength, and also high tensile strain at break and high weld seam strength.

Catalysts which may be used according to the invention are in principle any of the compounds which catalyze a chemical reaction between the polyacetal matrix polymer and the-surface of the additives, and which do not comprise the element of boron and which are not a Brönsted acid.

The chemical reactions may be either the reaction of reactive groups of the polyacetal matrix polymer with reactive groups on the surface of the additive, or may be chemical reactions in which covalent bonds are formed between coupling agents used and polyacetal matrix and/or a surface of the additive, or in which covalent bonds form between two portions of a coupling agent, one portion of which is compatible with the polyacetal matrix polymer and the other portion of which is compatible with the surface of the additives.

Examples of reactions catalyzed according to the invention for forming covalent bonds between the polyacetal matrix polymers and the surface of the additive are any of the reactions in which covalent bonds form between identical or different reactive groups.

Examples of reactive groups are hydroxy, thiol, mercaptan, amine, ester, amide, anhydride, carboxy, carbonate, sulfonic acid, epoxy, urethane, thiourethane, isocyanate, allophanate, urea, biuret, lactone, lactam, oxazolidine, and carbodiimide groups, and halogen atoms.

Examples of chemical reactions are reactions between identical reactive groups, such as transesterification, transamidation or transurethanization reactions; or reactions between different reactive groups, such as ester formation, amide formation, or urethane formation, or formation of carbon-carbon bonds.

Catalysts which are used according to the invention are preferably compounds which catalyze transesterification, transamidation or transurethanization reactions, or which catalyze the formation of ester groups, amide groups, and the urethane groups.

It is preferable to use compounds which can also be used as transesterification catalysts.

These are advantageously Lewis acids, but they cannot be Brönsted acids. The amounts of these compounds used according to the invention are up to 1.0% by weight, preferably from 0.00001 to 0.5% by weight, advantageously from 0.0005 to 0.03% by weight, and particularly advantageously from 0.0007 to 0.01% by weight, in particular from 0.0007 to 0.005% by weight, based on the total amount of the molding composition.

Examples of suitable catalysts are MgX₂, BiX₃, SnX₄, SbX₅, FeX₃, GaX₃, HgX₂, ZnX₂, AlX₃, TiX₄, MnX₂, ZrX₄, [R₄N]⁺_{q}A^{q-}, [R₄P]⁺_{q}A^{q-} where X may be a halogen atom, i.e. I, Br, Cl or F, and/or an —OR or —R group, where R is alkyl or aryl, q is a whole number from 1 to 3, and A is a q-valent anion, such as halide, sulfate, or carboxylate.

It is also possible to use mixtures of various catalysts.

Other, particularly advantageous catalysts are selected from the group consisting of phosphonium salts, phosphanes, ammonium salts, sulfonium salts, titanates, titanyl compounds, zirconates, and their mixtures.

Titanates and zirconates are preferably compounds of the formula I 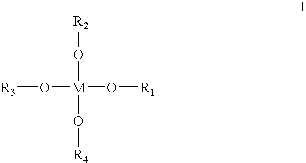
where M is titanium or zirconium and R₁, R₂, R₃, and R₄ are monovalent organic radicals which may be identical or different.

The radicals R₁ to R₄ may specifically be alkyl radicals having from one to twenty carbon atoms, where appropriate having substitution with one or more hydroxy or alkoxy groups and/or with halogen atoms, e.g. methyl, ethyl, hydroxyethyl, propyl, butyl, dodecyl, hexadecyl, or stearyl; aromatic groups which, where appropriate, may have substitution with one or more hydroxy or alkoxy groups and/or with halogen atoms, e.g. phenyl or naphthyl, or else condensed aromatic radicals, e.g. those derived from 2-halomethylnaphthalene, 9-halomethylanthracene, and 9-halomethyl-phenanthrene; araliphatic groups which, where appropriate, may have substitution with one or more hydroxy or alkoxy groups, and/or with halogen atoms, e.g. benzyl.

Titanates or zirconates which may be used advantageously are tetraalkyl titanates and tetraalkyl zirconates, where the R₁ to R₄ may be identical or different and have from 1 to 20 carbon atoms, advantageously from 2 to 10 carbon atoms, in particular from 3 to 8 carbon atoms.

Lower tetraalkyl titanates and lower tetraalkyl zirconates, e.g. titanium tetramethoxide, are often volatile, and for this reason preference should mostly be given to the less volatile higher homologs, such as titanium tetrabutoxide. Use may advantageously be made of titanium tetrabutoxide, zirconium tetrabutoxide, tetrapentyl titanate, tetrapentyl zirconate, tetrahexyl titanate, tetrahexyl titanate, tetraisobutyl titanate, tetraisobutyl zirconate, tetra-tert-butyl titanate, tetra-tert-butyl zirconate, triethyl tert-butyl titanate, triethyl tert-butyl zirconate, and similar compounds.

Other titanates or zirconates whose use is preferred are mixed oxides of the formulae Mt₄TiO₄, Mt₂TiO₃, Mt₂Ti₂O₅, Mt₂Ti₃O₇, Mt₄ZrO₄, Mt₂ZrO₃, Mt₂Zr₂O₅, and Mt₂Zr₃O₇, where Mt is a mono- or divalent metal, preferably an alkaline metal or an alkaline earth metal.

Titanyl compounds preferably have the structure [Ml^{p+}]ₛ[TiO]²⁺[A^{r-}]ₜ, where p is 1 or 2, s is 0, 1 or 2, Ml is a mono- or divalent metal, A is an r-valent anion, r and t, independently of one another, are 1 or 2, and s*p+2 is equal to r*t. Preferred values are p=1, s=0 or 2, r=1 or 2, and t=2.

Ml is preferably an alkali metal cation. A is preferably an anion of a mono- or dibasic carboxylic acid, such as acetic acid or oxalic acid. An example of a titanyl compound whose use is preferred is potassium titanyl bisoxalate (K₂[C₄O₉]Ti).

Phosphonium salts may particularly advantageously be used as catalyst according to the invention. Preferred phosphonium salts used according to the invention are compounds of the formula II 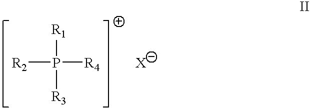
where R₁, R₂, R₃, and R₄ are identical or different, and may assume one of the definitions defined above, and where X may assume one of the definitions defined above.

Examples of particularly preferred phosphonium salts are 1-(acetylamino-2-phenylvinyl)triphenylphosphonium perchlorate, (1-benzoylamino-2,2-bis(4-Cl-phenylsulfanyl)vinyl)triphenylphosphonium chloride, (1-benzoylamino-2,2-bisethylsulfanylvinyl)triphenylphosphonium chloride, (1-benzoylamino-2,2-bisphenylsulfanylvinyl)triphenylphosphonium chloride, 1-(benzoylamino-2,2-dichlorovinyl)triphenylphosphonium chloride, (1-benzoylamino-2,2-dichlorovinyl)triphenylphosphonium iodide, (1-benzoylamino-2-(4-chlorophenyl)vinyl)triphenylphosphonium chloride, (1-benzoylamino-2-(4-Cl-phenylsulfanyl)vinyl)triphenylphosphonium chloride, (1-benzoylamino-2-(4-nitrophenyl)vinyl)triphenylphosphonium chloride, (1-benzoylamino-2-chlorovinyl)triphenylphosphonium chloride, (1-benzoylamino-2-Cl-2-ethylsulfanylvinyl)triphenylphosphonium chloride, tetraphenylphosphonium chloride, tetrabutylphosphonium chloride, dimethylbehenylphosphonium chloride, trimethyldodecylphosphonium chloride, trimethyloctadecylphosphonium chloride, trimethyl-hexadecylphosphonium chloride, tetrabutylphosphonium chloride, stearyltributylphosphonium chloride, tetraethylphosphonium bromide, tetrabutylphosphonium bromide, dimethylbehenylphosphonium bromide, trimethyldodecylphosphonium bromide, trimethyloctadecylphosphonium bromide, trimethylhexadecylphosphonium bromide, tetrabutylphosphonium bromide, stearyltributylphosphonium bromide.

Very particularly preferred phosphonium salts bear, as at least one of the radicals R₁ to R₄, an aryl radical, advantageously at least one phenyl radical, e.g. tetraphenylphosphonium chloride or tetraphenylphosphonium bromide. Particularly preferred phosphonium salts contain, as radicals R₁ to R₄, both aromatic and aliphatic radicals, in particular three aryl radicals, such as phenyl radicals. Examples of this group last mentioned are ethyltriphenylphosphonium chloride, ethyltriphenylphosphonium bromide.

Other suitable compounds are known to the person skilled in the art, and are readily obtainable and, by way of example, can be found at http://www.sigma-aldrich.com.

Other catalysts which may be used are the ammonium and sulfonium salts defined by analogy with formula II, and also phosphanes.

Preferred phosphanes are compounds of the formula IIa 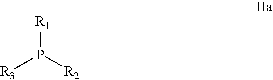
where the radicals R₁ to R₃ may be identical or different and are defined by analogy with the radicals R₁ to R₄ of the phosphonium salts represented in formula II.

Triphenylphosphane, P(C₆H₅)₃, is particularly advantageous.

The amounts used of the ammonium salts, sulfonium salts, and phosphanes, and also in particular the phosphonium salts, may advantageously be from 0.00001 to 0.03% by weight, particularly advantageously from 0.0005 to 0.025% by weight, very particularly advantageously from 0.0007 to 0.005% by weight.

However, since the mixing and homogeneous dispersion process is more difficult at very low concentrations (most for amounts markedly below 5 ppm), the amounts mostly used of these compounds are from 0.001 to 0.003% by weight.

Polyacetals (POMs) which may be used in the inventive process are polyoxymethylene homo- or copolymers.

Homopolymers of formaldehyde or of trioxane are polymers whose hydroxy end groups have been stabilized chemically in a known manner with respect to degradation, e.g. by esterification or etherification. Copolymers are polymers of formaldehyde or of its cyclic oligomers, in particular trioxane, with cyclic ethers, with cyclic acetals, and/or with linear polyacetals. In particular, the inventive process can also use what is known as the crude polymer. This is the reaction product from the cationic polymerization of trioxane and of one or more comonomers, using known initiators and, where appropriate, molecular weight regulators.

POM homo- or copolymers are known per se to the person skilled in the art and are described in the literature. These polymers very generally have at least 50 mol % of —CH₂O— repeat units in their main polymer chain.

The homopolymers are generally prepared via polymerization of formaldehyde or trioxane, preferably in the presence of suitable catalysts. Examples of suitable catalysts are boron trifluoride and trifluoro-methanesulfonic acid.

For the purposes of the invention, POM copolymers are preferred as component (A), in particular those which besides the —CH₂O— repeat units also contain up to 50 mol %, preferably from 0.1 to 20 mol %, and in particular from 0.5 to 10 mol %, of repeat units of the formula II 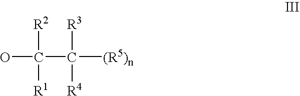
where R¹ to R⁴, independently of one another, are a hydrogen atom, a C₁-C₄-alkyl group, or a halogen-substituted alkyl group having from 1 to 4 carbon atoms, and R⁵ is —CH₂—, —CH₂O—, a C₁-C₄-alkyl-substituted or C₁-C₄-haloalkyl-substituted methylene group, or a corresponding oxymethylene group, and n is a value in the range from 0 to 3.

These groups may advantageously be introduced into the copolymers via ring-opening of cyclic ethers. Preferred cyclic ethers are those of the formula IV 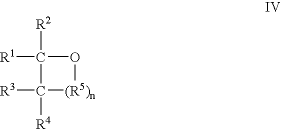
where R¹ to R⁵ and n are as defined above. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also linear oligo- or polyformals, such as polydioxolane or polydioxepan as comonomers.

Copolymers of from 99.5 to 95 mol % of trioxane and from 0.5 to 5 mol % of one of the abovementioned comonomers are particularly advantageous.

Oxymethylene terpolymers are also suitable and are obtained, for example, by reacting trioxane with one of the above-described cyclic ethers and with a third monomer, preferably a bifunctional compound of the formula V 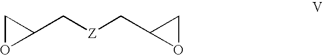
where Z is a chemical bond, —O—, or —ORO— (R=C₁-C₈-alkylene or C₂-C₈-cycloalkylene).

Preferred monomers of this type are ethylene diglycide, diglycidyl ether, and diethers composed of glycidyl units and formaldehyde, dioxane, or trioxane in a molar ratio of 2:1, and also diethers composed of 2 mol of glycidyl compound and 1 mol of an aliphatic diol having from 2 to 8 carbon atoms, for example the diglycidyl ethers of ethylene glycol, 1,4-butanediol, 1,3-butanediol, 1,3-cyclobutanediol, 1,2-propanediol, or 1,4-cyclohexane-diol, to mention just a few examples.

Processes for preparing the polyoxymethylene homo- and copolymers described above are known to the skilled worker and are described in the literature.

The preferred POM copolymers having melting points of at least 150° C. and molecular weights (weight-average) M_{w} in the range from 5000 to 200,000, preferably from 7000 to 150,000.

Particular preference is given to end-group-stabilized POM polymers whose chain ends have carbon-carbon bonds.

The POM polymers used generally have a melt index (MVR 190/2, 16) of from 1 to 50 cm³/10 min (ISO 1133).

Suitable additives are generally any of the additives which are present in a separate phase in the polymer matrix and whose surface can be covalently bonded via a chemical reaction to the polyacetal matrix. These may be typical reinforcing materials, such as fibers, tapes, films, or fiber sheet-like structures, or may be typical fillers, used mainly on grounds of cost-effectiveness, e.g. mineral fillers, or else fillers used to give a particular property to the composition, e.g. to achieve reinforcement, or else impact-modifiers.

These additives have advantageously been provided with a size, or have been surface-treated, in order to improve coupling to the polyacetal matrix.

This advantageously applies particularly in the case of mineral fillers and reinforcing fibers. Advantageous use may be made of the following mineral fillers: chalk, calcium carbonate, glass beads, hollow glass beads, talc, wollastonite, loam, molybdenum disulfide or graphite.

Reinforcing fibers of which use may advantageously be made are mineral fibers, such as glass fibers, polymer fibers, in particular organic high-modulus fibers, such as aramid fibers, or metal fibers, such as steel fibers, or carbon fibers.

These fibers may be in modified or unmodified form, e.g. provided with a size, or chemically treated, in order to improve adhesion to the plastic. Glass fibers are particularly preferred. The materials mostly used for treating glass fibers are organic silanes, in particular aminosilanes.

Specific examples of aminosilanes which may be used are 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Sizes based on polyurethanes may also be used advantageously.

The reinforcing fibers may be compounded into the polyacetal, for example in an extruder or kneader. However, the reinforcing fibers may also advantageously take the form of continuous-filament fibers sheathed or impregnated with the polyacetal molding composition in a process suitable for this purpose, and then processed or wound up in the form of a continuous strand, or cut to a desired pellet length so that the fiber lengths and pellet lengths are identical. An example of a process particularly suitable for this purpose is the pultrusion process.

According to the invention, the long-fiber-reinforced polyacetal molding composition may be a glass-fiber bundle which has been sheathed with one or more layers of the polyacetal matrix polymer in such a way that the fibers have not been impregnated and mixing of the fibers and the polyacetal matrix polymer does not take place until processing occurs, for example injection molding. However, the fibers have advantageously been impregnated with the polyacetal matrix polymer.

In one preferred embodiment of the invention, the long-fiber-reinforced polyacetal molding composition is prepared by the pultrusion process, where
i) fiber bundles are conducted through a flat die charged with a melt made from at least one polyacetal and, where appropriate, from other additives,
ii) the immersed fiber bundles are conducted through a shaping die,
iii) the fiber bundles are cooled,
iv) the fiber bundles are postformed, and
v) the fiber bundles are cut to the length of the structure perpendicular to their running direction, or are wound up in the form of a continuous structure.

The impregnation of the fiber bundles with the polyacetal matrix polymer, for example via pultrusion in step i) of the above process, may also take place by other suitable processes. For example, the fibers may be impregnated by a process in which the fiber bundle is saturated by a polyacetal matrix polymer, wherein the fiber bundle is laid onto carrier equipment, and wherein the carrier equipment, together with the fiber bundle lying thereon, is conducted through impregnating equipment. A process of this type is described in EP 756 536.

The fiber may also be impregnated by a process in which a plastifying extruder is used and a fiber strand is conducted by way of guide apertures and preheating equipment and is wetted with a liquid film of polyacetal in an impregnating apparatus and then is introduced into the plastifying extruder in which the individual fibers are chopped and mixed, the mixture being discharged in the form of a fiber-reinforced polyacetal composition capable of further processing, wherein the following steps are used:
a) passing by way of coating nozzles into the inlet of the plastifying extruder, and preferably parallel to the extruder axes and approximately tangentially, the fiber strand is wound up onto an extruder screw and around the extruder screws in an advancing direction, and also drawn into holes in the extruder barrel, whose diameter has been enlarged by at least four times the thickness of the fiber strand, where
b) in the inlet the right-hand coating nozzle directly applies a film of polyacetal to one flat side of the fiber strand, while application to the second flat side takes place indirectly by pressing the fiber strand into the liquid film of polyacetal previously applied from the left-hand coating nozzle to the screw, whereupon the individual continuous-filament fibers are subjected to impregnating or penetrating action at the extruder screws on both flat sides of the fiber strand in an inlet and impregnating section and these sides are wetted or saturated by the liquid films of polyacetal,
c) and then the fiber strand or the individual fibers thoroughly saturated or thoroughly impregnated with polyacetal are passed out of the inlet and impregnation section by way of a cutting edge into the short discharge and conveying section of a reduced-diameter barrel, and thus chopped into substantially predetermined lengths.

An example of the process of this type is described in DE 198 36 787.

The environmentally compatible and cost-effective process described of the invention gives a small rod-shaped structure of a certain shape. The length of the rod-shaped structure is from 3 to 100 mm, preferably from 4 to 50 mm, and particularly preferably from 5 to 15 mm. The diameter of the rod-shaped structure, also termed a pellet, is generally from 1 to 10 mm, from 2 to 8 mm, and particularly preferably from 3 to 6 mm.

The invention also provides a process where the components are mixed in an extruder, and the reinforcing fiber is wetted by the melt, and the resultant material is then pelletized. The resultant pellets may be mixed with dye and/or pigment and further processed to give the component.

According to the invention, the long-fiber-reinforced polyacetal molding composition may also be produced by the compounding process or by the direct process. It is particularly advantageous that the direct process does not give a rod-shaped structure which has to be shaped in another step of the process to give a molded article; instead, the molded article, reinforced with long reinforcing fibers (the length of the reinforcing fibers here being from 3 to 100 mm) is obtained directly from reinforcing fibers and from the polyacetal matrix polymer which comprises the catalyst.

According to the invention, a molded article is molded from the molten, where appropriate colored, long-fiber-reinforced polyacetal pellets in a manner known per se, e.g. injection molding, extrusion, blow molding, or plastification with compression.

According to the invention, the structure of the long-fiber-reinforced polyacetal molding composition has the shape of a rod, strip, ribbon, or sheet. The shape is preferably that of a rod, obtained by using polyacetal to coat the surface of the fiber and therefore of the bundle composed of fiber, arranged continuously and parallel, to give a strand, and then by cutting the product to the required length.

According to the invention, any of the components other than the reinforcing fiber may be mixed in the melt in a kneader or an extruder. The temperature is set above the melting point of the higher-melting polyacetal by from 5 to 100° K., preferably from 10 to 60° K. The mixing of the melt is complete after a period of from 30 seconds to 15 minutes, preferably from 1 minute to 10 minutes.

The nature of the long-fiber-reinforced polyacetal molding composition may also be such that there is substantial wetting of the fibers by the polyacetal or by a blend of polyacetals, and sheathing of the impregnated fiber strand in the middle of the long-fiber-reinforced polyacetal molding composition by another component, preferably a different thermoplastic or a blend, with bonding of the components to one another at the surface. A structure of this type may be produced by a process such as that described in U.S. Pat. No. 6,090,319, for example.

This type of long-fiber-reinforced polyacetal molding composition may be produced by
after fiber impregnation by one of the processes described above, drawing the impregnated fiber strand continuously out of the impregnation apparatus;
continuously melting the material intended for sheathing the long-fiber-reinforced polyacetal molding composition, and extruding it in the plastic state, as required by the length, through an elongate extrusion die with a completely open tubular passage in which the material intended for sheathing the polyacetal molding composition is present;
continuously conveying the impregnated fiber strand into and through said elongate extrusion die, while at the same time the material intended for sheathing the impregnated fiber strand is extruded;
and bringing the impregnated fiber strand into contact with the molten material intended for sheathing the long-fiber-reinforced polyacetal molding composition, and coating it, and obtaining a long-fiber-reinforced polyacetal molding composition in which there is substantial wetting of the fibers only by one of the components, and the impregnated fiber strand in the middle of the long-fiber-reinforced polyacetal molding composition has been sheathed by the respective other component, and the components have been bonded to one another at the surface;
continuously removing the long-fiber-reinforced polyacetal molding composition from the extrusion die; and
cutting the fiber bundles to give the length of the structure perpendicularly to their running direction, or winding them up in the form of a continuous structure.

When this process is used, the reinforcing fibers are impregnated by a known process, preferably by the pultrusion process, with one of the components, which, where appropriate, may comprise one or more other additives. The resultant structure is then coated with the other component, which in each case may also comprise one or more other additives.

The reinforcing fibers are preferably wetted by the component which advantageously comprises the catalyst, and the resultant strand is then sheathed by the other component, and this component, too, may comprise other additives.

The other additives present in the components spatially separate from one another here are advantageously different.

According to the invention, the long-fiber-reinforced polyacetal molding composition is used to produce moldings. These moldings have excellent mechanical properties, in particular excellent impact strength, high heat resistance, and low deformability. The moldings also have improved accuracy of fit, due to very low warpage.

The moldings may be produced from the inventive long-fiber-reinforced polyactal molding compositions by the known processing methods, for example via injection molding, compression molding, or blow molding.

Other advantageous additives which are used according to the invention are impact modifiers. The catalysts used according to the invention also improve the compatibility and the dispersibility of the impact modifiers in the polymer matrix, giving higher impact strengths.

This takes place “in situ”, i.e. during the melt kneading procedure a coupling reaction is promoted catalytically between the polyacetal and available functionalities of the impact modifier, producing what may be called a block copolymer, which acts as a compatibilizer across the phase boundary to improve thermodynamic miscibility and therefore compatibility within the mixture.

The amounts typically used of impact modifiers are from 5 to 50% by weight, preferably from 5 to 40% by weight, particularly preferably from 7 to 30% by weight.

Preferred materials used as impact modifier, individually or in the form of a mixture, are polyurethanes, two-phase mixers of polybutadiene and styrene-acrylonitrile (ABS), modified polysiloxanes or silicone rubbers, or graft copolymers of an elastomeric, single-phase core based on polydiene and of a hard graft shell (core-shell structure). In the latter case, impact modifiers are composed of particles most of which, preferably more than 70% of which, have a structure composed of core and shells. The core here is formed from an elastomeric polymer phase onto which has been grafted the hard shell, which may also be composed of two or more layers. The core is preferably single-phase, and this means that the core is composed mainly, preferably completely, of the elastomeric soft phase and comprises only small amounts of, preferably no, inclusions of hard polymer constituents of the shell. The graft polymer is mostly composed of from 40 to 95% by weight, advantageously from 60 to 90% by weight, particularly advantageously from 70 to 80% by weight, of the elastomeric core. The proportion of the shells is from 5 to 60% by weight, advantageously from 10 to 40% by weight, particularly advantageously from 20 to 30% by weight. The core is generally composed of polydienes, e.g. polybutadiene or polyisoprene, and may contain up to 10% by weight, advantageously up to 5% by weight, of comonomer units. Styrene or acrylonitrile may advantageously be used as comonomer. The core polymer may also have been crosslinked and have a gel content, measured in toluene, generally greater than 70%, and preferably greater than 80%. An example of a crosslinking agent which may be used is divinylbenzene. The shell of the particles is composed of hard polymers which have been grafted on to the core as graft substrate. The shell here may have a single- or multishell structure, advantageously a dual-shell structure. If there is more than one shell, the various layers are advantageously composed of different polymers or copolymers. It is advantageous here for the first layer to have been crosslinked. However, where appropriate, the other layers may also have been crosslinked.

These impact modifiers and their structure are known per-se and described by way of example in EP-A-156,285 and EP-A-668,317, the disclosure of which is expressly incorporated herein by way of reference.

The glass transition temperatures of the impact modifiers described above are usually from −40 to −120° C., preferably below −60° C., in particular from −80 to −120° C.

Other graft copolymers which may be used as impact modifiers are materials in which the core is composed mainly or entirely of preferably partially crosslinked polyacrylates or polymethacrylates whose alcohol component contains from 1 to 15 carbon atoms, preferably from 1 to 8 carbon atoms. Comonomers which may be used are olefinic monomers, advantageously butadiene, cyclooctadiene, vinyl ethers, and haloalkyl acrylates. The gel content, measured in toluene, is preferably at least 50%, particularly preferably at least 70%. For the graft shells, use may be made of the monomers and monomer mixtures described above. The particle sizes, too, are within the same range. Graft polymers based on polyacrylates and on polymethacrylates are described by way of example in DE-A-1,964,156, DE-A-2,116,653, EP-A-50,265, EP-A-60,601 and EP-A-64,207, incorporated herein by way of reference. The core of the graft polymer may also be composed entirely or partially of a silicone rubber and/or of non-crosslinked organopolysiloxanes. The monomers and/or monomer mixtures described above may be grafted onto this core, which preferably contains functional groups having grafting action. These materials are described by way of example in DE-A-2,659,357, incorporated herein by way of reference.

Other impact-modifying components or impact modifiers which may be used are polyurethanes, preferably thermoplastic polyurethanes. The polyurethanes which may be used according to the invention are known products, described by way of example in DE-A-1,193,240, DE-A-2,051,028 and the Kunststoff-Taschenbuch [Plastics handbook] (Saechtling, 27th edition, Hanser Verlag 1998) on pages 523-542, incorporated herein by way of reference.

The polyurethanes which may be used according to the invention are preferably thermoplastic and therefore preferably in essence non-crosslinked, i.e. capable of repeated melting without exhibiting any significant decomposition. Their reduced specific viscosities, measured at 30° C. in dimethylformamide, are generally from 0.5 to 3 dl/g, preferably from 1 to 2 dl/g. The values for tensile strain at break are advantageously from 800 to 1500%, preferably from 1000 to 1500%, while the Shore A hardness is at most 90, advantageously not above 81, preferably from 50 to 85, particularly preferably from 60 to 80, in particular from 65 to 80, and the glass transition temperatures are mostly not higher than 0° C., advantageously not higher than −10° C., particularly advantageously not higher than −20° C.

The polyacetal molding compositions according to the invention may optionally comprise amounts which are mostly up to 40% by weight of other additives, individually or in the form of a mixture. Examples of materials which may be used are formaldehyde scavengers, tribological auxiliaries, antioxidants, such as sterically hindered phenol compounds, UV stabilizers, such as benzotriazole derivatives and benzophenone derivatives, additives which confer conductivity or antistatic agents, such as carbon blacks, e.g. in particular conductive carbon blacks, acid scavengers, coupling agents, demolding aids, nucleating agents, such as polyoxymethylene terpolymers or talc, colorants, such as inorganic pigments, e.g. titanium dioxide, ultramarine blue, cobalt blue, or organic pigments and dyes, such as phthalocyanines, anthraquinones, lubricants, such as soaps and esters, e.g. stearyl stearate, montanic esters, partially saponified montanic esters, stearic acids, polar and/or non-polar polyethylene waxes, poly-α-olefin oligomers, silicone oils, polyalkylene glycols, and perfluoroalkyl ethers, polytetrafluoroethylene, or other additives, such as ultrahigh-molecular-weight polyethylene, and thermoplastic or thermoset polymer additives, elastomers, and other polymers.

Formaldehyde scavengers which may be used advantageously are from 0.01 to 1.0% by weight, preferably form 0.03 to 0.3% by weight, of a cyclic stabilizer which contains at least one nitrogen atom in the ring. Examples are pyrrolidine, piperidine, pyrrole, pyridine, purine, indole, carbazole, tryptophan, oxazole, imidazole, thiazole, picoline, lutidine, collidine, quinoline, pyridazine,. pyrimidine, pyrazine, and their derivatives. Heterocyclic compounds having at least one nitrogen atom as heteroatom are advantageous, where the heteroatom is adjacent either to an amino-substituted carbon atom or to a carbonyl group, examples being pyridazine, pyrimidine, pyrazine, pyrrolidone, aminopyridine, and compounds derived therefrom. Advantageous compounds of this class are aminopyridine and compounds derived therefrom. In principle, any of the aminopyridines is suitable, e.g. melamine, 2,6-diaminopyridine, substituted and dimeric aminopyridines, and also pyrrolidone and compounds derived therefrom, and mixtures prepared from these compounds. Examples of suitable pyrrolidones are imidazolidinone and compounds derived therefrom, e.g. hydantoin, its derivatives being particularly advantageous, and among these compounds allantoin and its derivatives have particular advantage. Other particularly advantageous compounds are triamino-1,3,5-triazine (melamine) and its derivatives, e.g. melamine-formaldehyde condensates and methylolmelamine. Very particular preference is given to melamine, methylolmelamine, melamine-formaldehyde condensates, and allantoin. The cyclic stabilizers which contain at least one nitrogen atom in the ring may be used individually or in a combination.

From 0.001 to 0.5% by weight of a metal salt of a carboxylic acid may also be used advantageously as formaldehyde scavengers. Salts of fatty acids are advantageous, in particular salts of higher fatty acids having from 10 to 32 carbon atoms, preferably from 14 to 32 carbon atoms, particular preference being given to salts of montanic acids and stearic acid. Preferred metals are those which occur in the form of mono- or divalent ions, e.g. alkali metals and alkaline earth metals, in particular alkaline earth metals. Particular preference is given to magnesium and calcium, e.g. calcium stearate. Magnesium stearate is very particularly preferred.

Formaldehyde scavengers may be used individually or in the form of mixtures.

Amounts which may be used of the sterically hindered phenol compounds are from 0.05 to 2.0% by weight, preferably from 0.1 to 1.0% by weight, particularly preferably from 0.2 to 1.0% by weight. Examples of these compounds are pentaerythrityl tetrakis[3-(3,5-di-tert-butyl-4-hydroxy-phenyl)propionate] (Irganox 1010, Ciba Geigy), triethylene glycol bis[3-(3-tert-butyl-4-hydroxy-5-methylphenyl)propionate] (Irganox 245, Ciba Geigy), 3,3′-bis[3-(3,5-di-tert-butyl-4-hydroxyphenyl)propio]hydrazide (Irganox MD 1024, Ciba Geigy), hexamethylene glycol bis[3-(3,5-di-tert-butyl-4 hydroxy-phenyl)propionate] (Irganox 259, Ciba Geigy), 3,5-di-tert-butyl-4-hydroxytoluene (Lowinox BHT, Great Lakes). Preference is given to Irganox 1010 and especially Irganox 245.

An amount of from 0.01 to 1.0% by weight, preferably from 0.05 to 0.8% by weight, of stabilizers from the benzotriazole derivatives group or benzo-phenone derivatives group or aromatic benzoate derivatives group may be present. Preference is given to 2-[2′-hydroxy-3′,5′-bis(1,1-dimethylbenzyl)-phenyl]benzotriazole, commercially obtainable as Tinuvin 234 (Ciba Geigy).

The inventive molding composition may comprise, as light stabilizer, by way of example, from 0.01 to 0.8% by weight, preferably from 0.05 to 0.5% by weight, very particularly preferably 0.4% by weight, of a sterically hindered amine light stabilizer (HALS). Preference is given to 2,2,6,6-tetra-methyl-4-piperidyl compounds, e.g. bis(2,2,6,6-tetramethyl-4-piperidyl) sebacate (Tinuvin 770, Ciba Geigy), or the polymer of dimethyl succinate and 1-(2-hydroxyethyl)-4-hydroxy-2,2,6,6-tetramethyl-4-piperidine (Tinuvin 622, Ciba Geigy).

The inventive polyoxymethylene molding compositions may be prepared by the usual and krnown mixing methods, such as pelletizing, extrusion, kneading, etc. The inventive molding compositions are preferably prepared by mixing polyoxymethylene polymer with additives and stabilizers and then pelletizing the mixture.

The inventive molding compositions have very good mechanical properties, in particular strength, impact strength, tensile strain at break, and weld line strength. There is an improvement here in the chemical coupling, and therefore the compatibility, between the additives and the polyacetal. The inventive molding compositions also feature the very low level of degradation or decomposition of the polyacetal, lower formaldehyde emissions, and improved resistance to fluids.

In the case of reinforcement with glass fibers, because the coupling is improved, the use of different fiber types with various size additives and various coupling agent additives can give very good mechanical properties which would not be obtainable when using boron-containing coupling agents. The advantages of the invention are in particular the very low level of decomposition of the polyacetal, higher stability and aging resistance, very low formaldehyde emission, high strength, impact strength, tensile strain at break, and weld line strength, better resistance in contact with fluids, and the action of the catalyst irrespective of the fiber type and material used as size.

### EXAMPLES

The examples below are intended to illustrate the invention for the person skilled in the art and to disclose other advantageous embodiments, but without limiting the scope of protection.

The base material used was the polyoxymethylene copolymer Hostaform 13021 from Ticona. Other auxiliaries used were 1.41% by weight of a mixture comprising melamine, nucleating agent, and antioxidant.

Glass fibers were used as additives. The glass fiber used was NEG T-651 H 11 μm glass fiber (producer: Nippon Electric Glass Co. Ltd., Osaka, Japan).

Experiments 1 to 4 are comparative examples.

Examples 5 to 19 are inventive.

No catalyst was used in experiment 1.

Boric acid was used in experiments 2 to 4.

The catalyst used comprised ethyltriphenylphosphonium bromide in experiments 5 to 8, tetraphenylphosphonium bromide in experiments 9 and 10, tetrabutylphosphonium bromide in experiments 11 and 12, triphenyl-phosphane in experiments 13 and 14, stearyltributylphosphonium bromide in experiments 15 and 16, and tetra-n-butyl titanate(IV) in experiments 17 to 19.

The amounts in the table are stated in % by weight, tensile strength and tensile modulus of elasticity are in MPa, tensile strain at break is in %, impact strengths are in kJ/m², TS values are in %, KS240 is in %/h (percent per hour).

The constituents were mixed with glass fibers and then extruded and pelletized through an extruder (ZSK 25MC twin-screw extruder, Werner & Pfleiderer, Germany) at a barrel temperature of 190° C. Test specimen production: the polyacetal pellets were injection molded to give standard test specimens and characterized by the methods listed below: tensile strength, tensile strain at break, tensile modulus of elasticity were determined by the tensile test to ISO 527. Charpy impact strength was determined to ISO 179-1/1eU for test specimens without notch or to ISO 179-1/1eA for test specimens with notch, by the tensile impact test.

The values for weight loss at 240° C. (thermal balance (KS 240)) are determined via heating of a specimen for from 25 to 60 minutes to 240° C. under nitrogen on a thermal balance. The weight loss in milligrams per unit of time is obtained. The weight loss is stated in percent per hour.

The values for 155° C. formaldehyde degradation are determined via heating of a specimen to 155° C. Formaldehyde emission from the polyacetal is determined here by using inert gas to displace the formaldehyde from the test chamber. The formaldehyde-loaded inert gas bubbles through a sodium sulfite solution. Formaldehyde reacts here with sodium sulfite to produce a solution of sodium hydroxide. (CH₂O+Na₂SO₃+H₂O→NaOH+CH₂(NaSO₃)OH). The resultant alkaline solution is titrated with acid.

The thermal stability of the polyacetal melt is determined by heating the specimen for 2 hours to 230° C. in air. The weight loss is stated in percent of the initial weight.

Tables 1 to 3 give the ingredients of the molding compositions and the corresponding test results.

Use of the catalysts improved mechanical properties, such as tensile strength, tensile strain at break, and, even more significantly, mechanical properties related to impact, in particular impact strength, giving an even more marked improvement in notched impact strength. The catalysts used also give a very low level of thermal degradation of the polyacetal (high thermal stability).

In particular, example 6, with 0.005% by weight of ethyltriphenyl-phosphonium bromide has very good mechanical properties together with a very low level of degradation of the polyacetal and low formaldehyde emissions (155° C. formaldehyde degradation value).

Even lower susceptibility of the polyacetal to decomposition, and higher stability, is shown in example 19. The simultaneous effect on tensile strength and stiffness is particularly significant here.

When comparison is made with boric acid, higher values for tensile strength, tensile strain at break, and notched impact strength are obtainable with a lower level of decomposition of the polyacetal, as can be seen in example 6.

TABLE 1

| Constituent/Properties | Unit | 1 | 2 | 3 | 4 | 5 | 6 | 7 |
|---|---|---|---|---|---|---|---|---|
| Polyoxymethylene copolymer | % by weight | 72.5900 | 72.5400 | 72.5600 | 72.5800 | 72.5600 | 72.5850 | 72.5890 |
| Additives | % by weight | 1.41 | 1.41 | 1.41 | 1.41 | 1.41 | 1.41 | 1.41 |
| Glass fiber | % by weight | 26 | 26 | 26 | 26 | 26 | 26 | 26 |
| Boric acid | % by weight | — | 0.05 | 0.03 | 0.01 | | | |
| P(Ph)₃EtBr | % by weight | — | | | | 0.03 | 0.005 | 0.001 |
| P(Ph)₄Br | | | | | | | | |
| P(Bu)₄Br | | | | | | | | |
| Stearyltributylphosphonium bromide | | | | | | | | |
| P(Ph)₃ | | | | | | | | |
| n-Butyl titanate(IV) | % by weight | | | | | | | |
| MVR 190/2.16 | ml/10 min | 3.0 | 4.1 | 3.8 | 4.0 | 4.9 | 3.8 | 3.5 |
| Tensile modulus of elasticity | MPa | 9320 | 9423 | 9599 | 9150 | 9181 | 9421 | 9495 |
| Tensile strength | MPa | 130 | 145 | 147 | 142 | 150 | 150 | 144 |
| Tensile strain at break | % | 2.4 | 2.8 | 2.8 | 2.9 | 3.0 | 3.1 | 2.8 |
| Impact strength (Charpy, 23° C.) | kJ/m² | 48 | 59 | 60 | 62 | 61 | 69 | 62 |
| Notched impact strength | kJ/m² | 6.5 | 9.0 | 9.3 | 9.1 | 9.7 | 11.1 | 9.7 |
| (Charpy, 23° C.) | | | | | | | | |
| Thermal stability (230° C.) | % | 1.4 | 7.3 | 4.9 | 3.5 | 5.9 | 2.1 | 2.0 |
| KS 240: thermal balance | %/h | 0.11 | 1.08 | 0.74 | 0.57 | 1.59 | | |
| 155° C., formaldehyde | ppm/h | 0 | 72 | 17 | 15 | 90 | 9 | 5 |
| degradation value | | | | | | | | |

TABLE 2

| Constituent/Properties | Unit | 8 | 9 | 10 | 11 | 12 | 13 | 14 |
|---|---|---|---|---|---|---|---|---|
| Polyoxymethylene copolymer | % by weight | 72.5893 | 72.5600 | 72.5850 | 72.5600 | 72.5850 | 72.5600 | 72.5850 |
| Additives | % by weight | 1.41 | 1.41 | 1.41 | 1.41 | 1.41 | 1.41 | 1.41 |
| Glass fiber | % by weight | 26 | 26 | 26 | 26 | 26 | 26 | 26 |
| Boric acid | % by weight | | | | | | | |
| P(Ph)₃EtBr | % by weight | 0.0007 | | | | | | |
| P(Ph)₄Br | | | 0.03 | 0.005 | | | | |
| P(Bu)₄Br | | | | | 0.03 | 0.005 | | |
| Stearyltributylphosphonium bromide | | | | | | | | |
| P(Ph)₃ | | | | | | | 0.03 | 0.005 |
| n-Butyl titanate(IV) | % by weight | | | | | | | |
| MVR 190/2.16 | ml/10 min | 3.4 | 3.6 | 3.4 | 3.3 | 3.6 | 3.3 | 3.1 |
| Tensile modulus of elasticity | MPa | 9603 | 9536 | 6510 | 9631 | 9632 | 9611 | 9498 |
| Tensile strength | MPa | 141 | 148 | 143 | 151 | 151 | 144 | 144 |
| Tensile strain at break | % | 2.7 | 2.9 | 2.7 | 2.9 | 2.9 | 2.7 | 2.8 |
| Impact strength (Charpy, 23° C.) | kJ/m² | 58 | 65 | 56 | 64 | 66 | 60 | 60 |
| Notched impact strength | kJ/m² | 8.9 | 10.5 | 9.2 | 10.7 | 10.8 | 9.3 | 9.1 |
| (Charpy, 23° C.) | | | | | | | | |
| Thermal stability (230° C.) | % | 1.9 | 2.2 | 2.2 | 5.2 | 2.2 | 1.8 | 1.8 |
| KS 240: thermal balance | %/h | | | | | | | |
| 155° C., formaldehyde | ppm/h | 5 | 15 | 10 | 14 | 18 | 4 | 4 |
| degradation value | | | | | | | | |

TABLE 3

| Constituent/Properties | Unit | 15 | 16 | 17 | 18 | 19 |
|---|---|---|---|---|---|---|
| Polyoxymethylene copolymer | % by weight | 72.5600 | 72.5850 | 72.0900 | 72.4900 | 72.5850 |
| Additives | % by weight | 1.41 | 1.41 | 1.41 | 1.41 | 1.41 |
| Glass fiber | % by weight | 26 | 26 | 26 | 26 | 26 |
| Boric acid | % by weight | | | | | |
| P(Ph)₃EtBr | % by weight | | | | | |
| P(Ph)₄Br | | | | | | |
| P(Bu)₄Br | | | | | | |
| Stearyltributylphosphonium bromide | | 0.03 | 0.005 | | | |
| P(Ph)₃ | | | | | | |
| n-Butyl titanate(IV) | % by weight | | | 0.500 | 0.100 | 0.005 |
| MVR 190/2.16 | ml/10 min | 3.5 | 3.4 | 3.8 | 3.7 | 3.0 |
| Tensile modulus of elasticity | MPa | 9514 | 9576 | 9353 | 12479 | 10079 |
| Tensile strength | MPa | 144 | 141 | 83 | 150 | 143 |
| Tensile strain at break | % | 2.7 | 2.6 | 1.5 | 2.0 | 2.6 |
| Impact strength (Charpy, 23° C.) | kJ/m² | 60 | 55 | 22 | 46 | 58 |
| Notched impact strength (Charpy, 23° C.) | kJ/m² | 9.7 | 9.0 | 5.3 | 7.1 | 8.8 |
| Thermal stability (230° C.) | % | 2.8 | 1.7 | 2.3 | 1.3 | 1.8 |
| KS 240: thermal balance | %/h | | | 0.14 | 0.17 | 0.13 |
| 155° C., formaldehyde degradation value | ppm/h | 1 | 0 | 3 | 5 | 0 |

The examples below describe the production of the inventive long-fiber-reinforced polyacetal molding composition.

Glass fibers were used as additives. The long-fiber-reinforced polyacetal structures studied were produced by the pultrusion process. To this end, a series of glass fiber bundles (E glass, 2200 tex direct roving, Star*Rov 860, producer: Johns Manville, Engineered Products Group, Denver, Colo., USA) was unwound continuously, heated, and then passed through a melt die. The melt die had been charged with a melt made from a polyacetal. The constituents of the melt were melted in advance in an extruder in the weight ratio stated in table 1. The base material used comprised the polyoxymethylene copolymer Hostaform 52021 from Ticona. Other additives used comprised 1.41% by weight of a mixture comprising melamine, nucleating agent, and antioxidant. The glass fiber bundles were immersed in the molten plastic in the melt die. The content of the glass fiber bundles in this step was set at 40% by weight by regulating the take-off speed for the glass fiber bundles and the amounts of molten polyacetal added. The glass fiber strands were conducted out of the melt die via a shaping die and a shaping roller, and cooled. The strands were then chopped by a strand pelletizer to give a rod-shaped structure of length 10 mm.

Experiments 20 to 21 are comparative examples. The inventive examples are 22 and 23. In experiment 20 no catalyst was used. In experiment 21 boric acid was used. The catalyst used in experiment 22 comprised ethyltriphenylphosphonium bromide, and in experiment 23 comprised tetra-n-butyl titanate(IV).

The amounts in the table are stated in % by weight, tensile strength and tensile modulus of elasticity are in MPa, tensile strain at break is in %, impact strengths are in kJ/m², TS is stated in % and the 155° C. test results in ppm/h (ppm of formaldehyde per hour). Test specimen production: the polyacetal pellets were injection molded to give standard test specimens and characterized by the methods listed below: tensile strength, tensile strain at break, tensile modulus of elasticity were determined by the tensile test to ISO 527. Charpy impact strength was determined to ISO 179-1/1eU for test specimens without notch or to ISO 179-1/1eA for test specimens with notch, by the tensile impact test.

The values for 155° C. formaldehyde degradation are determined via heating of a specimen to 155° C. Formaldehyde emission from the polyacetal is determined here by using inert gas to displace the formaldehyde from the test chamber. The formaldehyde-loaded inert gas bubbles through a sodium sulfite solution. Formaldehyde reacts here with sodium sulfite to produce a solution of sodium hydroxide. (CH₂O +Na₂SO₃+H₂O→NaOH+CH₂(NaSO₃)OH). The resultant alkaline solution is titrated with acid.

The thermal stability of the polyacetal melt is determined by heating the specimen for 2 hours to 230° C. in air. The weight loss is stated in percent of the initial weight.

Table 4 gives the ingredients of the molding compositions and the corresponding test results.

Use of the catalysts improved mechanical properties, such as tensile strength, tensile strain at break, and, even more significantly, mechanical properties related to impact, in particular notched impact strength, giving an even more marked improvement in impact strength. The catalysts used also give a very low level of thermal degradation of the polyacetal (low TS-value, high thermal stability).

In particular, example 22, with 0.005% by weight of ethyltriphenyl-phosphonium bromide has very good mechanical properties together with a very low level of degradation of the polyacetal and low formaldehyde emissions (155° C. formaldehyde degradation value).

When comparison is made with boric acid, higher values for tensile strength, tensile strain at break, impact strength, and notched impact strength are obtainable with a lower degree of degradation of the polyacetal, as can be seen in example 22.

TABLE 4

| Constituent/Properties | Unit | 20 | 21 | 22 | 23 |
|---|---|---|---|---|---|
| Polyoxymethylene copolymer | % by weight | 58.590 | 58.560 | 58.585 | 58.490 |
| Additives | % by weight | 1.41 | 1.41 | 1.41 | 1.41 |
| Glass fiber | % by weight | 40 | 40 | 40 | 40 |
| Boric acid | % by weight | | 0.03 | | |
| P(Ph)₃EtBr | % by weight | | | 0.00 | |
| n-Butyl titanate(IV) | % by weight | | | | 0.10 |
| Tensile modulus of elasticity | MPa | 1298 | 1384 | 1405 | 1347 |
| Tensile strength | MPa | 108 | 159 | 192 | 113 |
| Tensile strain at break | % | 1.2 | 1.6 | 2.0 | 1.1 |
| Impact strength (Charpy, 23° C.) | kJ/m² | 22 | 42 | 66 | 31 |
| Notched impact strength (Charpy, 23° C.) | kJ/m² | 15.9 | 24.8 | 25.9 | 25.0 |
| Thermal stability (230° C.) | % | | 5.6 | 3.0 | |
| 155° C., formaldehyde degradation value | ppm/h | | 33 | 9 | |

1. A polyacetal molding composition comprising
a) from 20 to 99% by weight of a polyacetal homo- or copolymer,
b) from 0.1 to 80% by weight of an additive, and
c) up to 1.0% by weight of a catalyst which catalyzes a chemical reaction between the polyacetal matrix polymer and the surface of the additive,
where the catalyst does not comprise the element boron and is not a Brönsted acid.

2. A long-fiber-reinforced polyacetal molding composition as claimed in claim 1 comprising
a) from 20 to 90% by weight of a polyoxymethylene homo- or copolymer,
b) from 10 to 80% by weight of a reinforcing fiber,
c) from 0.00001 to 0.5% by weight of at least one catalyst which catalyzes a chemical reaction between the polyacetal homo- or copolymer and the surface of the reinforcing fiber.

3. The polyacetal molding composition as claimed in claim 1, wherein the amount of component a) is from 20 to 99% by weight, that of component b) is from 0.1 to 80% by weight, and that of component c) is from 0.00001 to 0.5% by weight.

4. The polyacetal molding composition as claimed in claim 1, wherein a catalyst or a mixture of catalysts is used which catalyzes transesterification, transamidation, or transurethanization reactions, or which catalyzes the formation of ester groups, amide groups, and urethane groups.

5. The polyacetal molding composition as claimed in claim 1, wherein the catalyst is selected from the group consisting of phosphonium salts, phosphanes, ammonium salts, sulfonium salts, titanates, titanyl compounds, zirconates, and their mixtures.

6. The polyacetal molding composition as claimed in claim 1, wherein the additive is selected from the group consisting of mineral fillers, reinforcing fibers, impact modifiers, and their mixtures.

7. The polyacetal molding composition as claimed in claim 6, wherein the impact modifier is selected from the group consisting of polyurethanes, two-phase mixtures of polybutadiene and styrene-acrylonitrile (ABS), modified polysiloxanes, silicone rubbers, graft copolymers of an elastomeric, single-phase core based on polydiene and a hard graft shell (core-shell structure), and mixtures of these components.

8. The polyacetal molding composition as claimed in claim 1, wherein the catalyst is selected from the group consisting of ethyltriphenylphosphonium bromide, tetraphenylphosphonium bromide, tetrabutylphosphonium bromide, stearyltributylphosphonium bromide, triphenylphosphane, n-butyl titanate, and their mixtures.

9. The polyacetal molding composition as claimed in claim 2, wherein the long-fiber-reinforced polyacetal molding composition is a glass-fiber bundle which has been sheathed with one or more layers of the polyacetalhomo- or copolymer, so that the fibers have been impregnated with the polyacetalhomo- or copolymer.

10. The polyacetal molding composition as claimed in claim 9, wherein the glass-fiber bundle has been wetted by the polyacetal homo- or copolymer or by a blend of polyacetal homo- or copolymers and the impregnated glass-fiber bundle has been sheathed by another component, and the impregnated glass-fiber bundle and the other component have been bonded to one another at the surface.

11. A molded article obtainable via shaping of a polyacetal molding composition as claimed in claim 1.

12. The polyacetal molding composition as claimed in claim 1, wherein the catalyst is selected from the group consisting of phosphonium salts, phosphanes, sulfonium salts, titanyl compounds, and their mixtures.

13. The polyacetal molding composition as claimed in claim 1, wherein the catalyst is a titanyl compounds of the structure [Ml^{p+}]ₛ[TiO]²⁺[A^{r-}]ₜ, wherein p is 1 or 2,
s is 0, 1 or 2,
Ml is a mono- or divalent metal,
A is an r-valent anion,
r and t, independently of one another, are 1 or 2, and
s*p+2 is equal to r*t.

14. The polyacetal molding composition as claimed in claim 13, wherein
Ml is an alkali metal cation,
A is an acetic acid or oxalic acid,
p=1,
s=0 or 2,
r=1 or 2, and
t=2.

15. The polyacetal molding composition as claimed in claim 1, wherein the catalyst is phosphonium salts which are compounds of the formula II 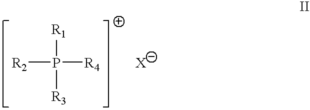
where R₁, R₂, R₃, and R₄ are identical or different, and are monovalent organic radicals, X is be a halogen atom, and/or an —OR or —R group, where R is alkyl or aryl.

16. The polyacetal molding composition as claimed in claim 15, wherein
R₁ to R₄ are identical or different and have from 2 to 10 carbon atoms and at least one of the radicals R₁ to R₄, is an aryl radical.

17. The polyacetal molding composition as claimed in claim 1, wherein the catalyst is phosphanes of the formula IIa 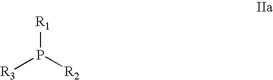
where the radicals R₁ to R₃ are identical or different, and are monovalent organic radicals.
